(19) United States
(12) Patent Application Publication
(10) Pub. No.: US 2024/0013103 A1
(43) Pub. Date: Jan. 11, 2024

(54) SYSTEM AND METHOD OF OFFERING CHAPERONE CARE SERVICES TO NURSING HOME TYPE CLIENTS FOR NON-EMERGENY SERVICES

(71) Applicant: Githae Peter Simon, Toronto (CA)

(72) Inventor: Githae Peter Simon, Toronto (CA)

(21) Appl. No.: 17/688,003

(22) Filed: Jul. 5, 2022

(51) Int. Cl. G06Q 10/02; G06Q 50/30; G06Q 30/04

(52) U.S. Cl. CPC G06Q 10/025; G06Q 50/30; G06Q 30/04

(57) ABSTRACT

A system and methods of matching activity, specialized personnel, transport vehicle to Nursing home type clients for non-emergency services upon request, including an Interface Independent database, one or a series of intelligent Billing modules that compute various data combinations and accurately bills for the service for prepayment, considering other sources of contributions like Medicare and Medicaid, promotions, discounts and other related cost deflators.

### CROSS-REFERENCE TO RELATED APPLICATIONS

The present application claims priority to U.S. provisional patent application Ser. No. 62/960,842. The entire disclosure is included here in its entirety at least by reference.

### BACKGROUND OF THE INVENTION

### 1. Field of the Invention

The present invention is in the field of electronics and pertains particularly to methods of providing auxiliary services to nursing home type clients.

### 2. Description of Related Art

In the public transport industry, much of the design and operation caters for able bodies commuters with relative reasonable accommodation for commuters with disability or the elderly. Uber has accommodation for pick up and drop off. But none offer specialized services to the specific clients in need with specialized personnel.

Therefore, what is clearly needed is a service that not only accommodates the special needs of Nursing Home Type clients but one that can call on specific specialized care personnel and type of vehicle for a specific on-demand activity. These activities can be a doctors appointment, Picnic, Shopping, dining out and visiting to a sports event and so on.

### BRIEF SUMMARY OF THE INVENTION

### Brief Description of the Several Views of the Drawings

FIG. 1 is a block diagram illustrating different options of requesting a Chaperone Care service according to the embodiment of the present invention.

FIG. 2 is a block diagram illustrating Chaperone Care system according to the embodiment of the present invention.

FIG. 3 is a block diagram illustrating Client user systems according to the embodiment of the present invention.

FIG. 4 is a block diagram illustrating Chaperone user system according to the embodiment of the present invention.

FIG. 5 is a block diagram illustrating comprising Billing module components of the Chaperone Care systems according to the embodiment of the present invention.

FIG. 6 is a flow chart illustrating steps for requesting a chaperone service according to the embodiment of the present invention.

### DETAILED DESCRIPTION OF THE INVENTION

The inventor provides a system of providing service to Nursing Home type clients as an auxiliary service to the regular care offered at their facility of residence. The present invention is described in enabling detail in the following examples, representing more than one embodiment.

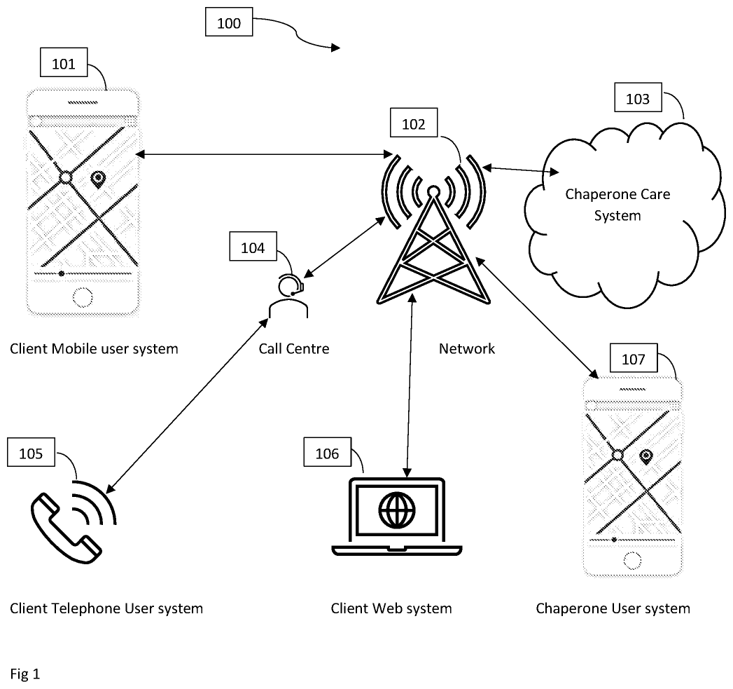

FIG. 1 is a block diagram illustrating different methods of requesting a Chaperone Care service according to the embodiment of the present invention. In the example 100 FIG. 1 comprises network 102. In various embodiments, network 102 comprises one or more of the following: a local area network, wide area network, wired network, wireless network, the Internet, an intranet, a storage area network, a cellular network, or any other appropriate communication network. Chaperone Care system 103, Client user systems 101, 104, 105, 106 and Chaperone user 107 comprise user systems as an example of computing operations at the users' disposal. In some embodiments, one or more of Client user system 101, 104, 105, 106 and Chaperone user system 107 comprises systems accessed by a user remotely, for example the user may not in proximity to the Chaperone care system. In some embodiments Client user systems 101, 104, 105, 106 and Chaperone user system 107 comprise access by a user remotely, for example the user may be in proximity to the user system and accesses the user's system through network 102 and a separate user system. In the example 100 the Client user system 101 and Chaperone User system 107 comprise mobile device (for example mobile phones, tablet, computers etc. using a wireless connection). In the example 100 the Client Web user system 106 comprise a device connected to a local area network, wide area network or world wide web (for example Mainframe computer, Desktop Computer terminal, fixed automated system, Artificial Intelligence Bots etc.) or any other appropriate systems. In the example 100 the Call Center user system 104 and Client telephone user system 105 comprise fixed devices connected to a local area network, wide area network, wired network, wireless network, the Internet, an intranet, a storage area network, a cellular network, or any other appropriate communication network (for example, fixed telephones lines, TTY line, Call Center, Artificial Intelligence Bots etc.). Chaperone Care system 103 comprises a system that connects Nursing home type client with a chaperone, vehicle, service, billing module or any other appropriate system component. In some embodiments the Chaperone Care system 103 comprises a system that determines certain specifically skilled Chaperones depending on the client's needs and level of dependencies or any other appropriate combinations. In some embodiments the Chaperone Care system 103 determines the type of vehicle configurations depending on the client's needs or levels of dependency and services requested or any appropriate combinations. In various embodiments the Chaperone Care system 103 comprises a computer, a computer with several processors, multiple computers connected through a local area network, multiple computers connected through a wide area network, multiple computers connected through the world wide web, several computers connected to the Chaperone Care system 103 or any other computing system or systems. In various embodiments the processors comprising Client user system 101, 104, 105, 106, Chaperone user system 107 and the Chaperone Care system 103 comprise any variety of proprietary or commercially available single or multi-processor systems (for example Inter, AMD etc.) or any other commercially processors available to support communications in accordance with each embodiment and application.

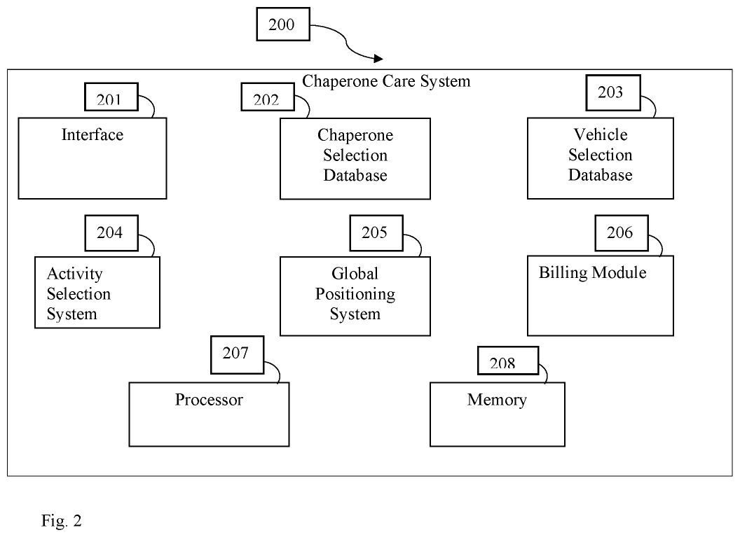

FIG. 2 is a block diagram illustrating Chaperone Care system 103 according to the embodiment of the present invention. In some embodiments Chaperone Care system 200 of FIG. 2 comprises Chaperone care system 103 of FIG. 1. In the example 200 comprises Interface 201. In various embodiments, Interface 201 comprises an Interface used to give limited access to Chaperone Care service, receiving a service notification, sending a service acceptance or denial indication, receive connection notifications, sending location information, sending, and receiving the beginning and end of service information, sending, and receiving any other appropriate information. In the example shown 200, in some embodiments, Chaperone Selection database 202 comprises the inventory of skill and personnel available to a client at a point in time or any other appropriate inventory. Chaperone Selection database 202 receives information sent by Interface 201 and selects a Chaperone from the Chaperone Selection database 202 in accordance with the requested service, the level of need and dependency of the client or any other appropriate selection criteria. In some embodiment, the Interface 201 send the Chaperone selection information to the Chaperone Care system 103. In some embodiments, Vehicle Selection Database 203 comprises the available vehicle configurations available to the client at a point in time or any other appropriate inventory. Vehicle Selection database 202 receives information sent by Interface 201 and selects a Vehicle with the appropriate configuration from the Vehicle Selection database 203 in accordance with the requested service, the level of need and dependency of the client or any other appropriate selection criteria. In some embodiment, the Interface 201 send the Vehicle selection information to the Chaperone Care system 103. In some embodiments, Activity Selection System 204 comprises an inventory of popular activities available to the client or any other appropriate activity. Activity Select system 204 receives information sent by Interface 201 and selects an Activity from the Activity Select system 204 in accordance with the requested service and the level of need and dependency of the client or any other appropriate selection criteria. In some embodiment, the Interface 201 send the Activity selection information to the Chaperone Care system 103. In example 200, Global Positioning System (GPS) 205 comprises a GPS for determining the Client user system position. In some embodiments, GPS position location is transmitted by Interface 201 to the Chaperone Care system 103. In example 200. In some embodiments, Billing module 206 comprises of the billing criteria for invoicing service combination received from Chaperone Care system 103 or any other appropriate information. In some embodiments Billing module 206 receives information sent by Interface 201 and determines the appropriate amount to invoice for the service. In some embodiments Billing information is sent to the Chaperone Care system 103. Processor 207 received information from the Interface 201 and determines what information should be sent by Interface 201. Memory 208 comprises a memory coupled with Processor 207 and configured to Processor 207 with instructions.

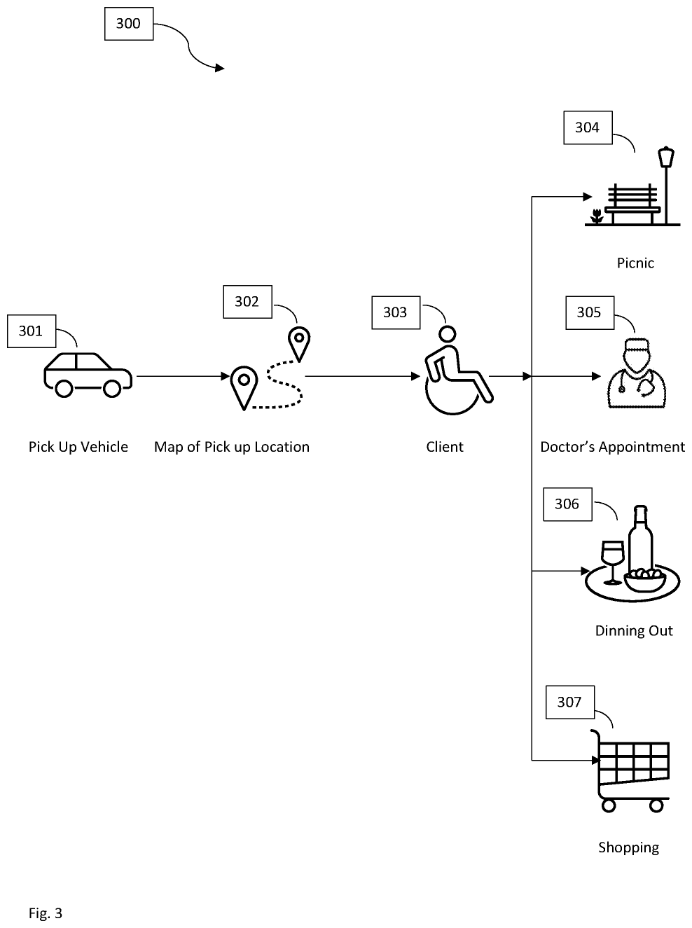

FIG. 3 is a block diagram illustrating Client user systems (for example 101, 104, 105, 106) according to the embodiment of the present invention. In the example shown 300 comprises Client user systems 101,104,105,106. In the example shown 300, comprises visuals of Vehicle types 301 drawn from Vehicle Selection system 203. In some embodiment vehicle type 301 could refer to any other appropriate vehicle (for example are remodeled van etc.) that may serve the type of dependency a client may have (example one may be dependent on a walker and another a wheelchair) or any other appropriate vehicle. Map 302 indicates the location of the client and proximity of available services. In some embodiments Map 302 may indicate the boundary of service beyond which a service may or may not be available. In some embodiments, Map 302 may indicate a point of interest for the clients desired activity or any other appropriate location. Client 303 indicate the client type and aid in vehicle and Chaperone selection. In other embodiments Client 303 may be used to indicate disability, dependency, or any other appropriate indication. Activity 304 may indicate a picnic, activity 305 may indicate a doctor's appointment, activity 306 may indicate dinning out, activity 307 may indicate shopping. In some embodiments, activity 304 may refer to any outdoor activity or any other appropriate activity. In some embodiments, activity 305 may indicate other medical services or any other appropriate service. In some embodiments, activity 306 may indicate leisure and recreation or any other appropriate activity. In some embodiments, activity 307 may indicate browsing retail stores, visit to a Mall, Online shopping, or any other appropriate activity.

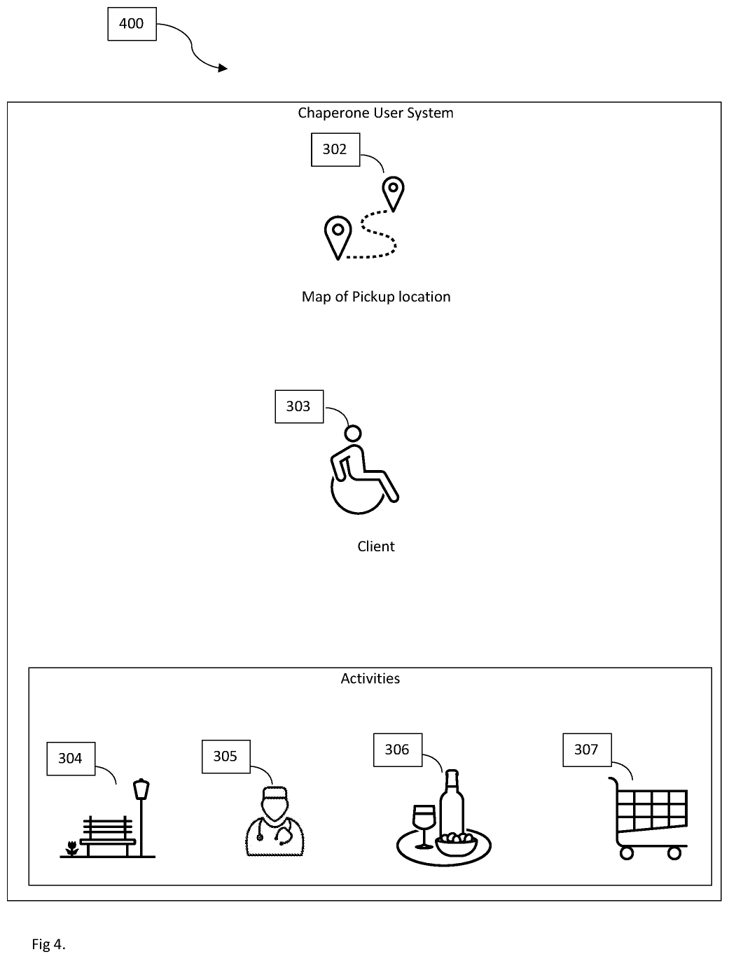

FIG. 4 is a block diagram 400 illustrating Chaperone user system 107 according to the embodiment of the present invention. In some embodiments, Map 302 may indicate a pickup location of the Nursing home type client or any other appropriate indication. In some embodiments, Map 302 may indicate the point of interest for the clients desired activity or any other appropriate location. Client type 303 may indicate the client type and aid in vehicle and Chaperone selection or any other appropriate service. In other embodiments Client type 303 may be used to indicate disability, dependency, or any other appropriate indication. Activity 304 may indicate a picnic, activity 305 may indicate a doctor's appointment, activity 306 may indicate dinning out, activity 307 may indicate shopping. In some embodiments, activity 304 may refer to any outdoor activity or any other appropriate activity. In some embodiments, activity 305 may indicate other medical services or any other appropriate service. In some embodiments, activity 306 may indicate leisure and recreation or any other appropriate activity. In some embodiments, activity 307 may indicate browsing retail stores, visit to a Mall, Online shopping, or any other appropriate activity.

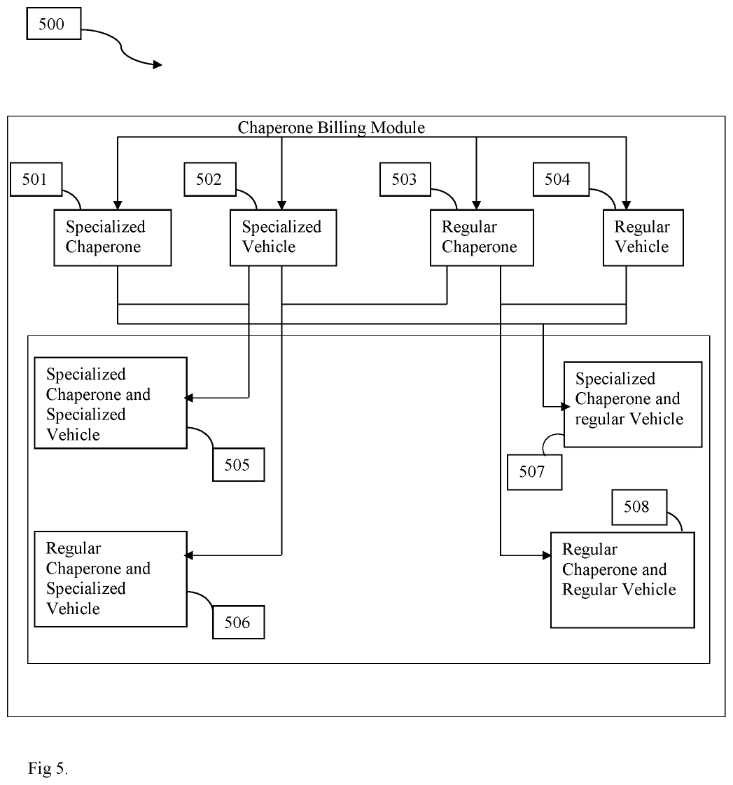

FIG. 5 is a block diagram 500 illustrating Billing module 206 comprising of the Chaperone Care systems 103 according to the embodiment of the present invention. In the shown example 500, in various embodiments, Chaperone database 202 comprises Specialized Chaperone 501, Regular Chaperone 503 or any other appropriate selection. In the shown example 500, in various embodiments, Vehicle database 203 comprises Specialized Vehicle 502, Regular Vehicle 504 or any other appropriate selection. In the example shown Billing module 206 utilizes information input from Chaperone Care system 103 and determines the billing amount for the service or any other appropriate output. In some embodiments, Combination 505 comprises is an example of a combination of a selected skill (for example Specialized Chaperone etc.) and Specialized Vehicle (for example remodeled van etc.) or any other appropriate combinations. In some embodiments, combination 506 comprises is an example of a combination of a selected skill (for example regular Chaperone etc.) and Specialized Vehicle (for example remodeled van etc.) or any other appropriate combinations. In some embodiments, combination 507 comprises is an example of a combination of a selected skill (for example Specialized Chaperone etc.) and regular Vehicle (for example a regular van etc.) or any other appropriate combinations. In some embodiments, combination 508 comprises is an example of a combination of a selected skill (for example regular Chaperone etc.) and regular Vehicle (for example a regular van etc.) or any other appropriate combinations.

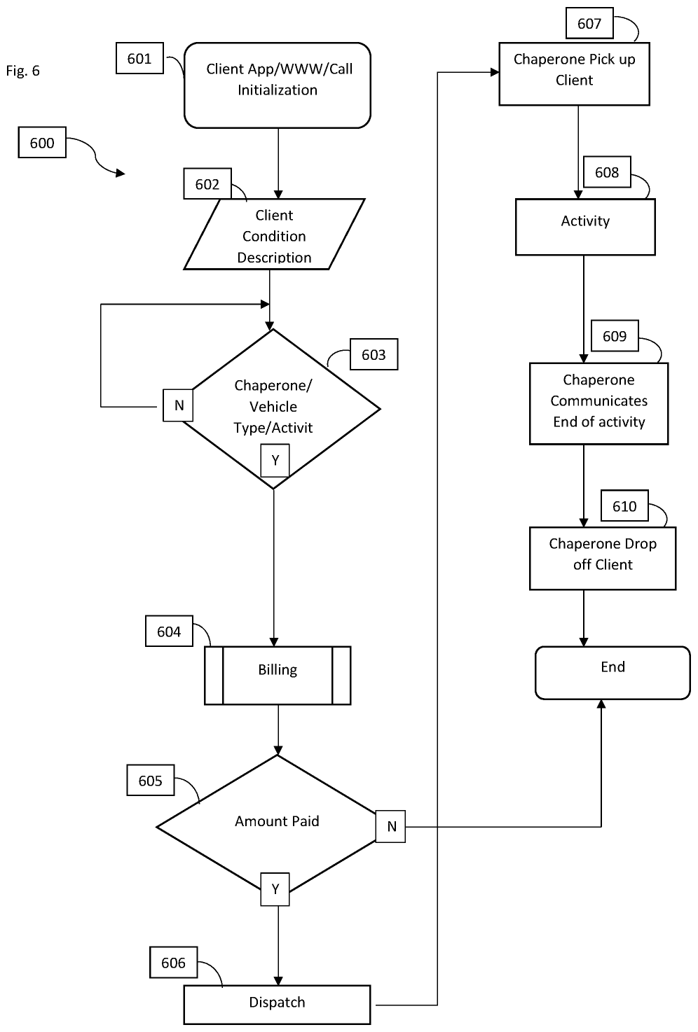

FIG. 6 is a flow chart 600 illustrating steps for requesting a chaperone service according to the embodiment of the present invention. In the example shown, step 601 the Client initializes the service using any of the user systems (for example Client mobile user system 101, Client web service 106 or Client telephone user system etc.) or any other appropriate system. At step 602 for example, the information input at step 601 is processed to determine the level of dependency of the client or any other appropriate determination. At step 603 for example the Chaperone Care system 103 will process the information received from 602 and determine allocations of a chaperone from the Chaperone database 202 and vehicle from Vehicle database 203 and consider the activity to arrive at the appropriately combination of the service offering or any other appropriate determination. If the combination is not complete the Chaperone Care system 103 will iterate the process for the next best combination and reallocate the input to step 603 or any other appropriate determination. At step 604 for example, the output of the combination information in step 603 is input into the billing in step 604, the billing module 206 processes the inform and display the invoiced amount on Client Interface 202 or any other appropriate output. At step 605 for example the client will opt to proceed with payment or end the request process or any other appropriate action. At step 606 for example the Chaperone Care system 103 dispatches the appropriate chaperone and vehicle once payment is received or any other appropriate action. At step 607 for example the dispatched Chaperone and Vehicle picks up the client or any other action. At step 608 for example, the chaperone provides the requested service to the client or any other appropriate action. At step 609 for example, the chaperone communicates with the dispatch through the Chaperone Care system 103 indicating the end of the activity or any other appropriate action. At step 610 for example the chaperone drops off the client and communicates the drop off to the Chaperone Care system 103 or any other appropriate action.

What is claimed is:

1. A system, comprising: at least one processor; and at least one non-transitory computer readable storage medium storing instructions that, when executed by at least one processor, cause the system to:
analyze, utilizing algorithm, activity corresponding to activity selection system, to generate activity; select activity location corresponding to the activity selection system; receive an activity request associated with a client user system of a client's choice,
wherein the activity request includes a client profile;
based on determining that the client profile corresponds to client user system, select a chaperone corresponding to the chaperone selection system for the activity request; and provide, for display, the selection to at least one of chaperone selection system or vehicle selection system.
wherein the activity request includes an activity location;
based on determining that the activity location corresponds to global positioning system, select a pick-up location corresponding to the activity selection system for the activity request; and provide, for display, the selection to at least one of chaperone selection system or vehicle selection system.
wherein the activity request includes a chaperone profile;
based on determining that the client profile corresponds to chaperone selection system, select a chaperone corresponding to the chaperone selection system for the activity request; and provide, for display, the selection to at least one of chaperone selection system or vehicle selection system.
wherein the activity request includes a vehicle configuration;
based on determining that the client profile corresponds to client user system, select a vehicle configuration corresponding to the vehicle selection system for the activity request; and provide, for display, the selection to at least one of chaperone selection system or vehicle selection system.
wherein the activity request includes billing amount;
based on determining that the client profile corresponds to client user system, select a generated billing amount corresponding to the billing module for the activity request; and provide, for display, the selection to the billing module.

2. The system of claim 1, further comprising instructions that, when executed by at least one processor, cause the system to:
analyze the client profile to generate a chaperone selection comprises utilizing algorithm comprising the chaperone selection system; and activity comprising activity selection system; and select the billing amount corresponding to the activity comprises selecting vehicle configuration based on the client profile for the activity and location.

3. The system of claim 2, further comprising instructions that, when executed by at least one processor, cause the system to select a chaperone by:
identifying a client request corresponding to the client user system for the activity request; identifying client profile corresponding to client user system for an activity; and selecting a vehicle configuration comprising client activity request.

4. The system of claim 2, further comprising instructions that, when executed by at least one processor, cause the system to select the initial activity request by:
determining the first priority based on a client user system input method comprising the initial client user system; and determining the second priority based on the second client user system input method comprising the second client user system.

5. The system of claim 2, further comprising instructions that, when executed by at least one processor, cause the system to select a chaperone by:
determining the client corresponding to the client profile; and vehicle configuration, determining order of priorities of clients' requests corresponding to activity requests.

6. The system of claim 2,
wherein:
the client user system input method comprises at least one of user input of an address via client user system; and activity selection system comprises utilizing the Global Positioning System (GPS).

7. The system of claim 1,
Wherein:
the client pick-up location and activity location correspond to the activity selection system and global positioning system.

8. A system-generated method, comprising:
analyze, utilizing algorithm, activity corresponding to activity selection system, to generate activity; select activity location corresponding to the activity selection system; receive an activity request associated with a client user system of a client's choice,
wherein the activity request includes a client profile;
based on determining that the client profile corresponds to client user system, select a chaperone corresponding to the chaperone selection system for the activity request; and provide, for display, the selection to at least one of chaperone selection system or vehicle selection system.
wherein the activity request includes an activity location;
based on determining that the activity location corresponds to global positioning system, select a pick-up location corresponding to the activity selection system for the activity request; and provide, for display, the selection to at least one of chaperone selection system or vehicle selection system.
wherein the activity request includes a chaperone profile;
based on determining that the client profile corresponds to chaperone selection system, select a chaperone corresponding to the chaperone selection system for the activity request; and provide, for display, the selection to at least one of chaperone selection system or vehicle selection system.
wherein the activity request includes a vehicle configuration;
based on determining that the client profile corresponds to client user system, select a vehicle configuration corresponding to the vehicle selection system for the activity request; and provide, for display, the selection to at least one of chaperone selection system or vehicle selection system.
wherein the activity request includes billing amount;
based on determining that the client profile corresponds to client user system, select a generated billing amount corresponding to the billing module for the activity request; and provide, for display, the selection to the billing module.

9. A system-implemented method of claim 8,
wherein:
analyzing the profile of the client to generate a vehicle configuration comprises utilizing algorithm to generate billing amount comprising activity and vehicle configuration comprising a client user system; and chaperone selection system corresponding activity selection system comprises selecting chaperone based on chaperone profile and vehicle selection system based on the client profile.

10. A system-generated method of claim 9,
wherein selecting the activity comprises:
identifying a chaperone corresponding to chaperone selection system from the chaperone care system; identifying a vehicle configuration corresponding to vehicle selection system from the chaperone care system, and applying a first priority to the activity request and a second priority to the second activity request to select activity request.

11. A system-generated method of claim 10,
wherein selecting the activity further comprises:
determining the first priority based on a client user system input method with regard to the client user system; and determining the second priority based on a client user system input method with regard to the client user system.

12. A system-generated method of claim 11,
wherein selecting the activity further comprises:
determining locations corresponding to the activity location; and for pick-up location, determining vehicle selection corresponding to chaperone selection.

13. The computer-implemented method of claim 12,
wherein:
the client user system input method comprises at least one of activity selection system or GPS location; and the activity selection system input method comprises utilizing a GPS location determined via chaperone care system.

14. A non-transitory computer readable medium storing instructions thereon that, when executed by at least one processor, cause the system to:
analyze, utilizing algorithm, activity corresponding to activity selection system, to generate activity; select activity location corresponding to the activity selection system; receive an activity request associated with a client user system of a client's choice,
wherein the activity request includes a client profile;
based on determining that the client profile corresponds to client user system, select a chaperone corresponding to the chaperone selection system for the activity request; and provide, for display, the selection to at least one of chaperone selection system or vehicle selection system.
wherein the activity request includes an activity location;
based on determining that the activity location corresponds to global positioning system, select a pick-up location corresponding to the activity selection system for the activity request; and provide, for display, the selection to at least one of chaperone selection system or vehicle selection system.
wherein the activity request includes a chaperone profile;
based on determining that the client profile corresponds to chaperone selection system, select a chaperone corresponding to the chaperone selection system for the activity request; and provide, for display, the selection to at least one of chaperone selection system or vehicle selection system.
wherein the activity request includes a vehicle configuration;
based on determining that the client profile corresponds to client user system, select a vehicle configuration corresponding to the vehicle selection system for the activity request; and provide, for display, the selection to at least one of chaperone selection system or vehicle selection system.
wherein the activity request includes billing amount;
based on determining that the client profile corresponds to client user system, select a generated billing amount corresponding to the billing module for the activity request; and provide, for display, the selection to the billing module.

15. The non-transitory computer readable medium of claim 14, further comprising instructions that, when executed by at least one processor, cause the chaperone care system to:
analyze the client profile to generate a chaperone selection comprises utilizing algorithm comprising the chaperone selection system and activity comprising activity selection system; and select the billing amount corresponding to the activity comprises selecting vehicle configuration based on the client profile for the activity and location.

16. The non-transitory computer readable medium of claim 15, further comprising instructions that, when executed by at least one processor, causes the system to select a client profile by:
identifying a client request corresponding to the client user system for the activity request; identifying client profile corresponding to client user system for an activity; and selecting a vehicle configuration comprising client activity request.

17. The non-transitory computer readable medium of claim 15, further comprising instructions that, when executed by at least one processor, cause the computer system to select the initial activity by:
determining the first priority based on a client user system input method comprising the initial client user system; and determining the second priority based on the second client user system input method comprising the second client user system.

18. The non-transitory computer readable medium of claim 14, further comprising instructions that, when executed by at least one processor, cause the chaperone care system to select the activity location by:
the client user system input method comprises at least one of user input of an address via client user system; and activity selection system comprises utilizing the Global Positioning System.

19. The non-transitory computer readable medium of claim 14, further comprising instructions that, when executed by at least one processor, cause the system to select the activity location by:
the client pick-up location and activity location correspond to the activity selection system and global positioning system

20. The non-transitory computer readable medium of claim 17,
wherein:
the client user system input method comprises a user input of a location via user interface of client user system comprises utilizing a GPS location determined via client user device.
